(19) United States
(12) Patent Application Publication
(10) Pub. No.: US 2008/0316172 A1
(43) Pub. Date: Dec. 25, 2008

(54) Manual input device

(76) Inventor: Hans M. Schulz, Muenchen (DE)

Correspondence Address: IP STRATEGIES, 12 1/2 WALL STREET, SUITE E, ASHEVILLE, NC, 28801, US

(21) Appl. No.: 11/781,430

(22) Filed: Jul. 23, 2007

(30) Foreign Application Priority Data
Jun. 22, 2007 (EP) PCT/EP2007/056286

(51) Int. Cl. G06F 3/033

(52) U.S. Cl. 345/163

(57) ABSTRACT

A manual input device configured for translating a planar movement of the manual input device into an electrical signal, comprising a site for accommodating at least one finger tip top down, the site being configured such that the manual input device can be moved in any planar direction by means of at least one finger tip of a hand, the wrist thereby resting planar.

The invention relates to a manual input device, also termed a (computer) mouse.

By far the most popular input device in addition to the keyboard is the mouse. It is used to control the cursor on the graphics user interface (GUI) of a computer (PC) and/or for triggering an action (clicking, scrolling and the like).

The mouse usually has a housing shaped similar to a bar of soap with a flat bottom incorporating a mechanical and/or optical device which senses the motion of the mouse over a pad and transmits it to the cursor on the display in thus permitting operating the computer. On the top of the mouse one or more buttons are incorporated for the confirmation (clicking) as well as scroll wheel or touch pad for navigating or “paging” through lengthy documents or the like.

The mouse is usually held between thumb and middle or ring finger, the buttons and the scroll wheel on the top of the mouse being operated by the index or middle finger.

It is this arrangement that results in the following problem which depending on the application and individual circumstances can be a real nuisance:

Whilst when just typing the mouse can be parked repeatedly, in 2D and CAD/3D applications as well as in computer games or the like it has to be held practically all the time. Since, however, the mouse is moved, scrolled or button-operated or held just for a fraction of the working time, the hand (particularly the index and middle finger) is permanently stressed for most of the time. This constitutes a static strain on the motor activity of the hand which can culminate in the strain prompting muscular tension, tendinitis, tendosynovitis in the hand, arm and shoulder (“mouse arm”) as well as in the region of the nape of neck, even to the extent of a CV syndrome. In addition to this, to move the mouse flat practically the whole hand is involved.

All this results in pain, loss of working hours and even occupational disability when extreme.

Manufacturers of conventional, what are called, ergonomic mouse devices attempt to solve this problem by designing the mouse rounder or better tactile. This, however, changes nothing as to the basically wrong positioning of the hand (the actual problem) and the resulting static strain caused by the mouse having to be held all the time with the hand strained to be able to move it. Indeed, in the more modern design with generously dimensioned buttons this problem becomes even worse because the hand/fingers have even less room for variations. For, as soon as the hand (or index finger) is relaxed the button is unintentionally pressed. In other words, the hand or fingers need to be continually strained poised over the buttons/scroll wheel so as not to press a button unintentionally.

It is thus the object of the invention to provide a manual input device which eliminates the cited problems at least in part.

In general, in one aspect, this invention provides a manual input device configured for translating a planar movement of the manual input device into an electrical signal, comprising: a site for accommodating at least one top down finger tip, the site being configured such that the manual input device can be moved in any planar direction by means of at least one finger tip of a hand, the wrist thereby resting planar.

Whilst a conventional mouse thus has to be guided and moved with the aid of the motor activities of the lower arm and wrist, guiding and moving the mouse in accordance with the invention is now possible solely by the finger tips, the ball of the thumb or wrist remaining parked planar. In addition, moving the mouse is now achieved in a relaxed position of the hand since the finger tips are sited on a flat site of the mouse, practically level with the ball of the thumb or wrist. When small movements of the mouse are needed, for instance when working with pixel accuracy with graphics software, the mouse in accordance with the invention now makes it possible to use the fine motoric capabilities of the hand for precise control. Pinpoint control of the mouse is now effortlessly enhanced by lightly crooking or spreading the fingers guiding the mouse (even with the wrist resting).

A further advantage is that due to its function principle the mouse is now no longer bound to a certain contour and need not comprise a minimum volume because it no longer needs to be held by the hand. For instance, the mouse can now be configured totally flat. It can also be profiled optionally convex or concave or recessed, e.g. for optimizing its weight, material savings or for adapting it to outer boundary conditions.

The size of the computer mouse is now dictated solely by the concavities, apertures and/or tactile surfaces for the finger tips.

In addition, variants are possible in which the computer mouse can be saved in notebooks, PDAs or the like during transport, or also variants in cheque card format, etc.

The mouse as described in the following is profiled flat fully or in part and incorporates one or more concavities and/or holes and/or tactile surfaces having a corresponding (rubberized) surface designed and arranged so that they can accommodate one or more finger tips in thus permitting movement of the mouse.

In other words, the mouse no longer needs to be held in the hand, it instead now being finger tip guided.

Advantageous implementations can include one or more of the following features.

The site in which the finger tip(s) are accommodated may be designed with one or more concavities and/or apertures. Apertures are e.g. particularly of advantage when the manual input device is designed extra thin or flat.

Preferably the controls (buttons/scroll wheel/touch pad and the like) can be sited so that they are no longer located under, but in front of, alongside or behind the fingers or thumb, resulting in the finger tips and thumb now resting in a totally relaxed and natural posture (lightly crooked) on the planar site or concavities of the mouse. Similar to pulling a pistol trigger, the button is now activated by crooking the finger.

Now, because of this design, as long as the mouse is not being moved or a control (buttons/scroll wheel/touch pad and the like) actuated no force whatsoever is needed, thus freeing the hand of static strain.

The number of concavities for accommodating the fingers can be made a function of the the precision and motion intensity for which the mouse is engineered. Thus, it may be that mobility is more accurate with several fingers so that a mouse having e.g. four concavities for four fingers is best suitable for particularly precise applications, whilst a mouse having just a single concavity for one finger may prove much better suitable for fast minute movements. A mouse featuring a larger free site is particularly well suited for applications requiring a lot of time, because the fingers can now ,rest” on the free site without actuating an unwanted function.

The device provided for sensing and translating motion of the mouse on the underside of the mouse is located to advantage away from the vertical by the fulcrum of the manual input device relative to the horizontal. This now makes it possible to translate a rotational movement of the mouse substantially about the vertical into a translation motion of the cursor. When the fulcrum coincides with the center of gravity of the mouse as regards a rotation in the (table) plane, the mouse can be maneuvered, particularly rotated with minimum effort.

The invention will now be detailed with reference to the drawing in which:

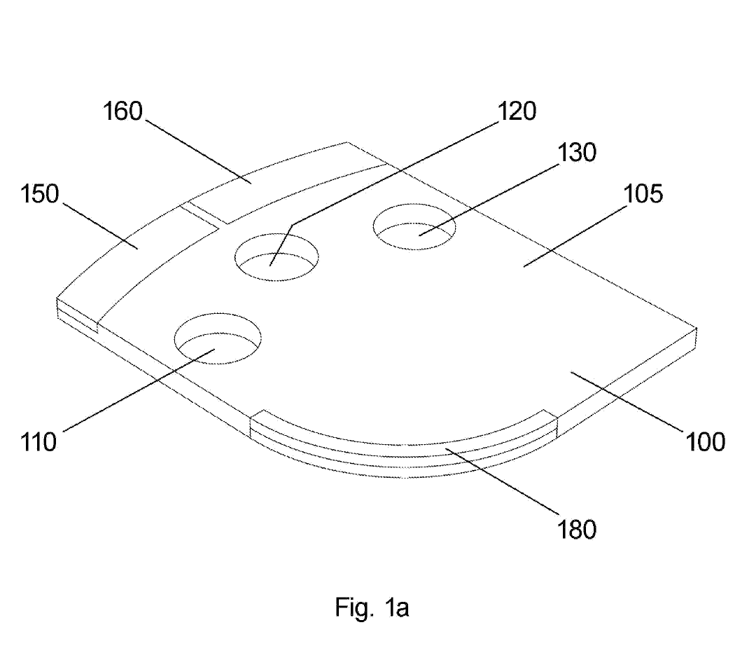

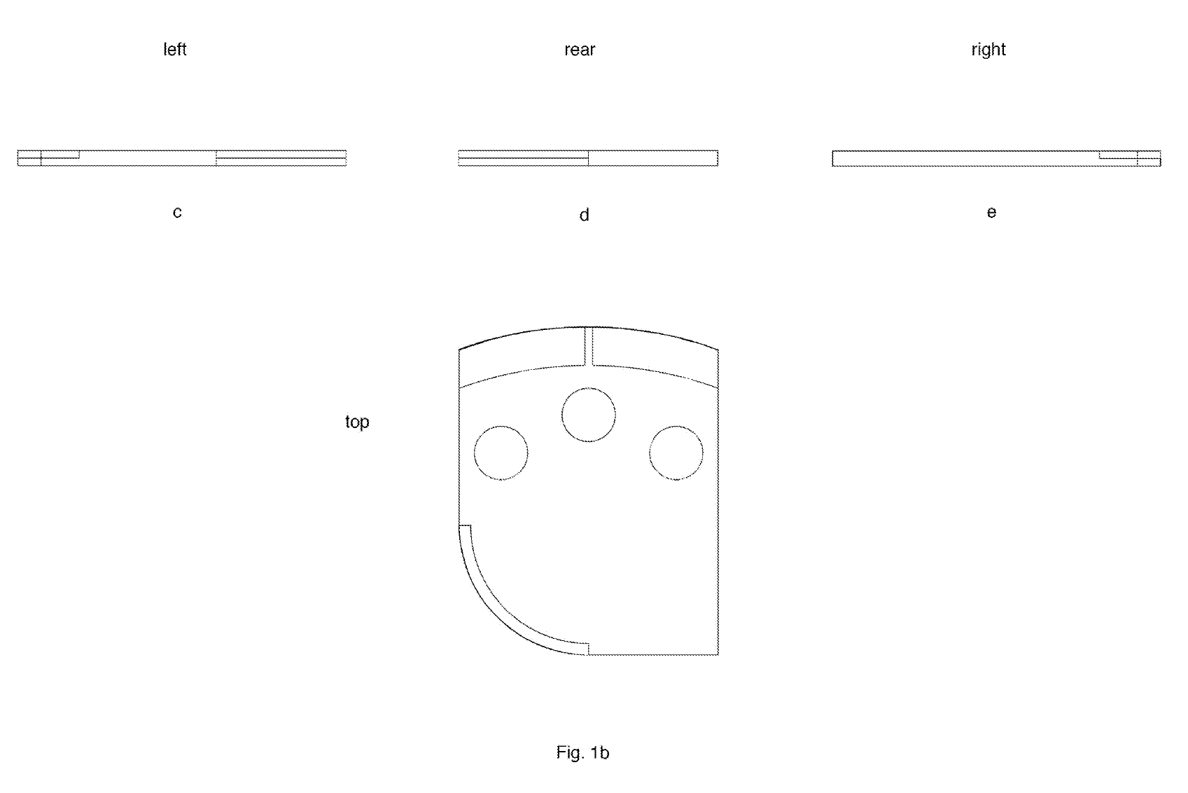

FIG. 1 shows a first embodiment of the invention;

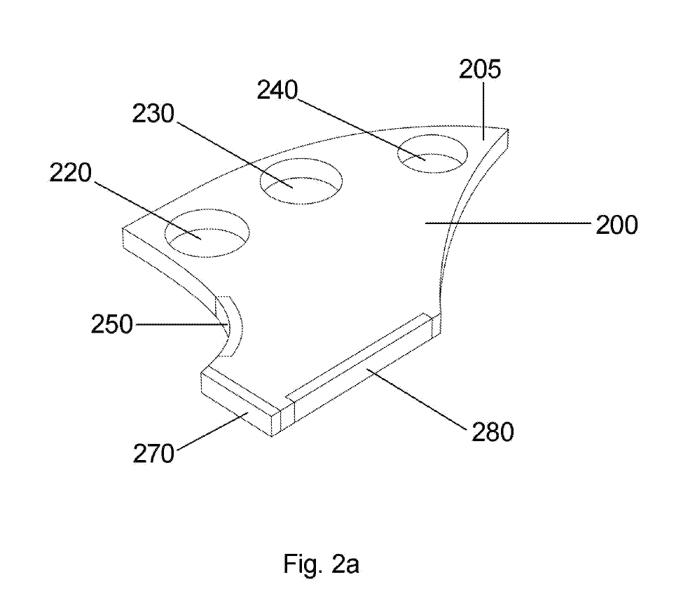

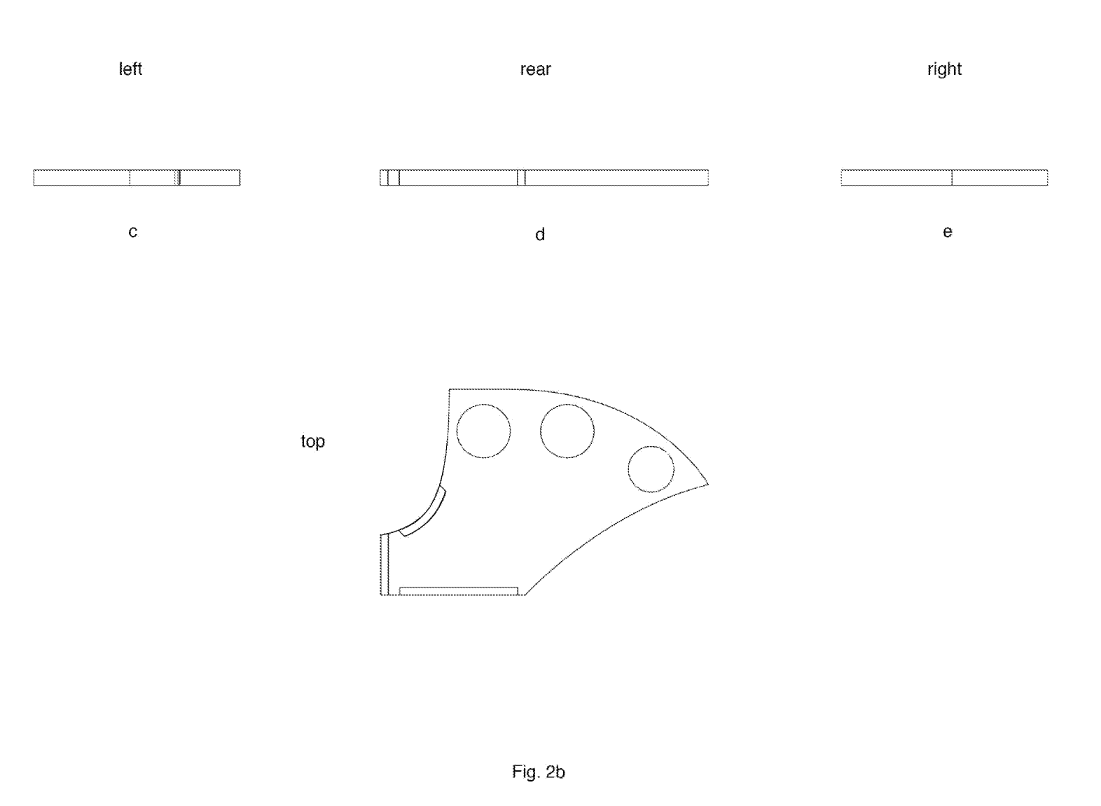

FIG. 2 shows a second embodiment of the invention;

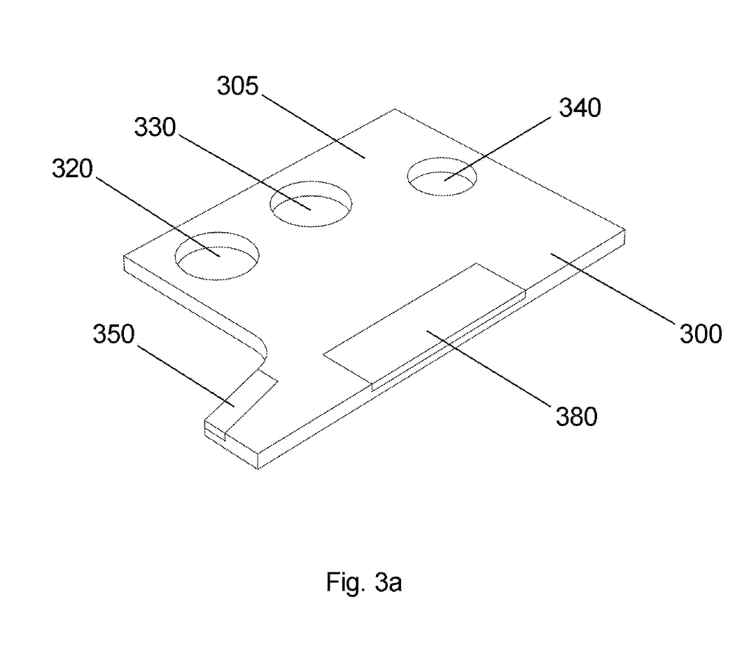

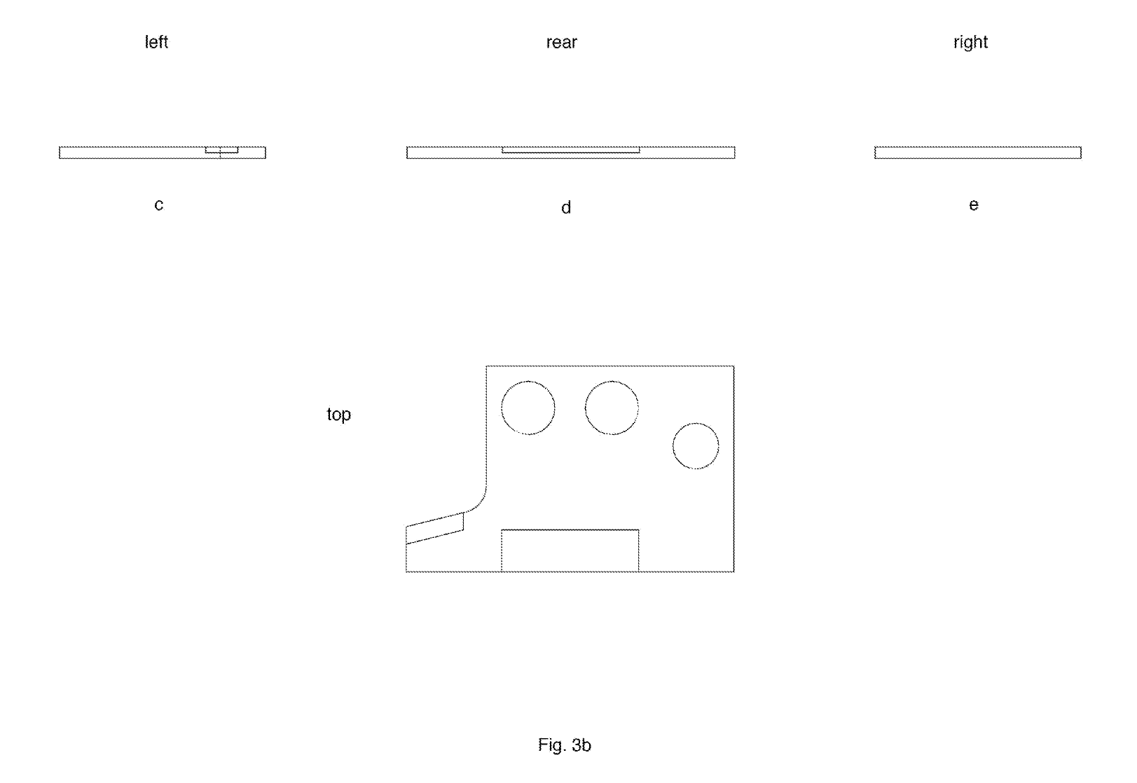

FIG. 3 shows a third embodiment of the invention;

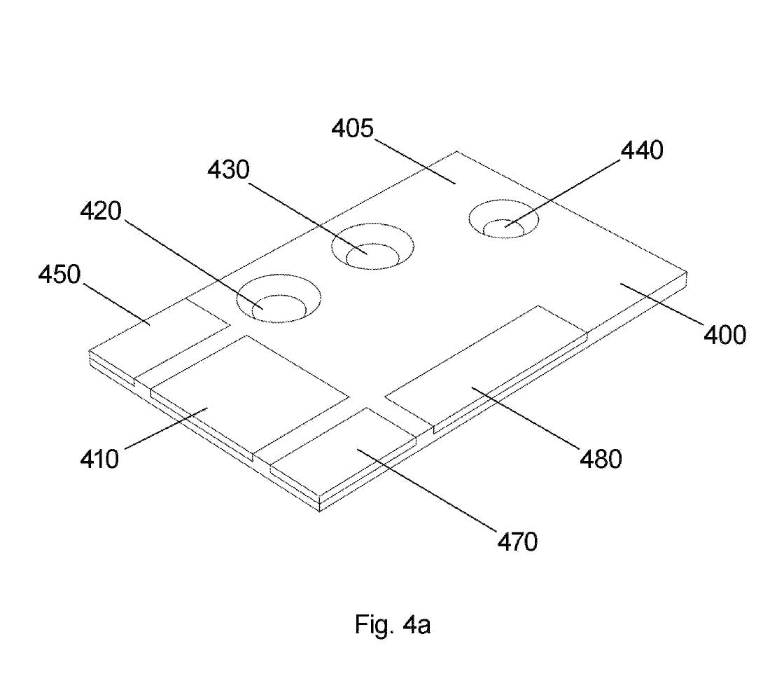

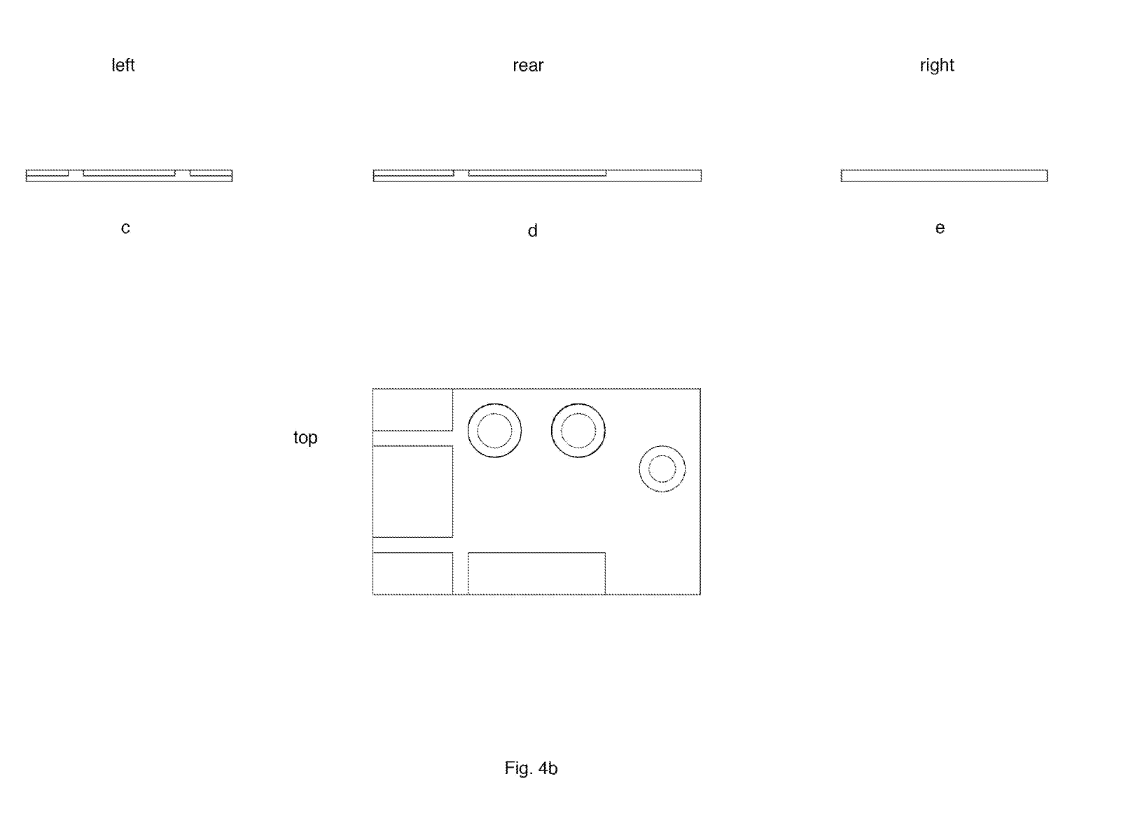

FIG. 4 shows a fourth embodiment of the invention;

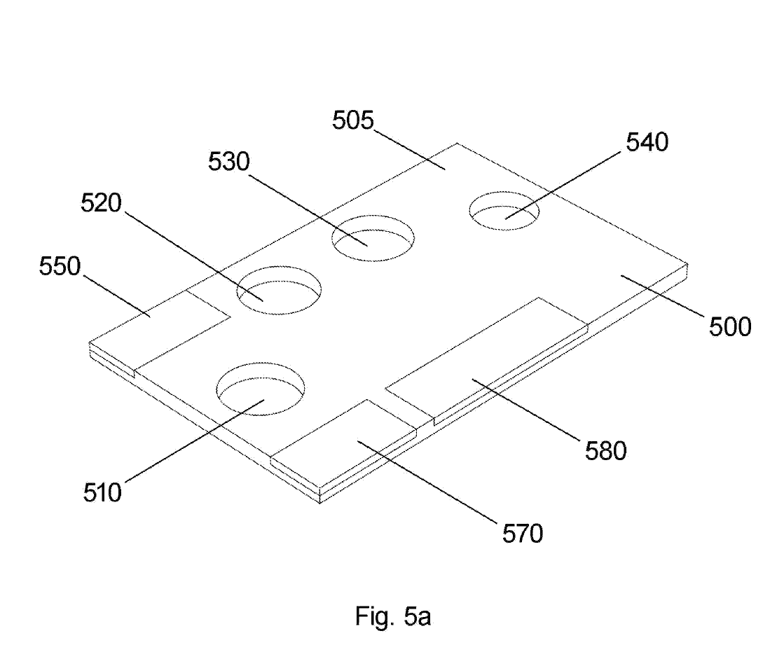

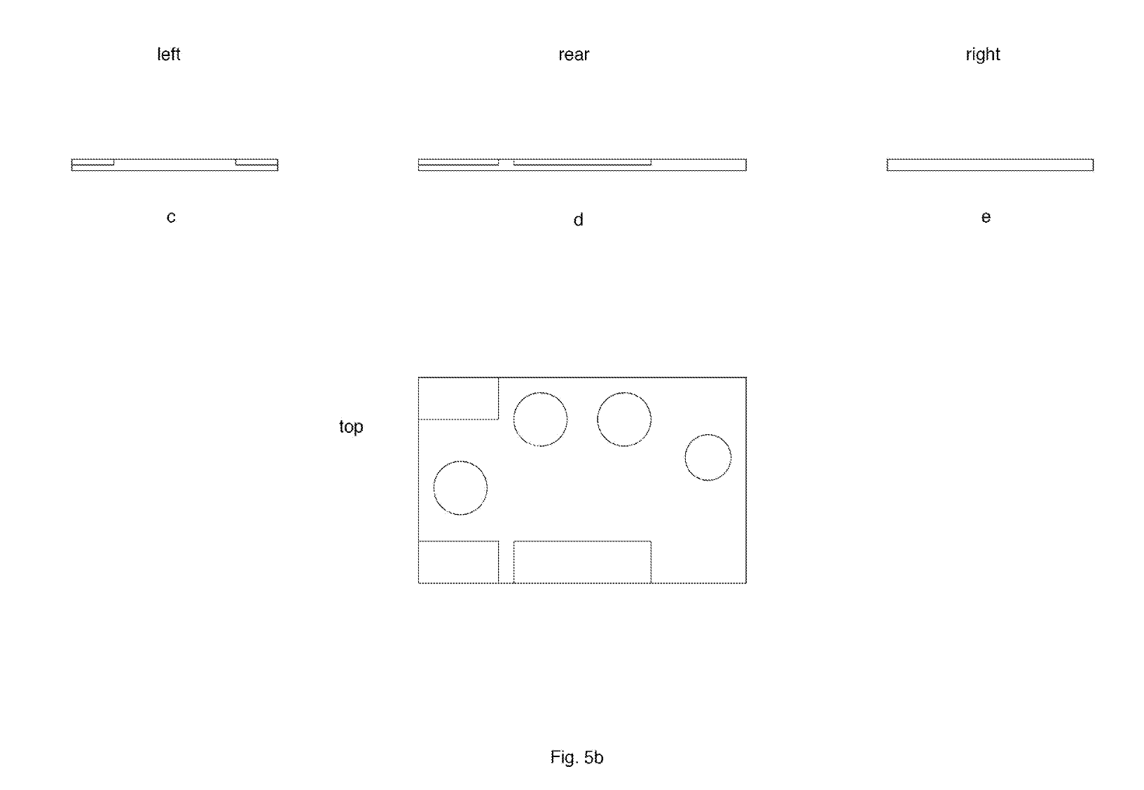

FIG. 5 shows a fifth embodiment of the invention;

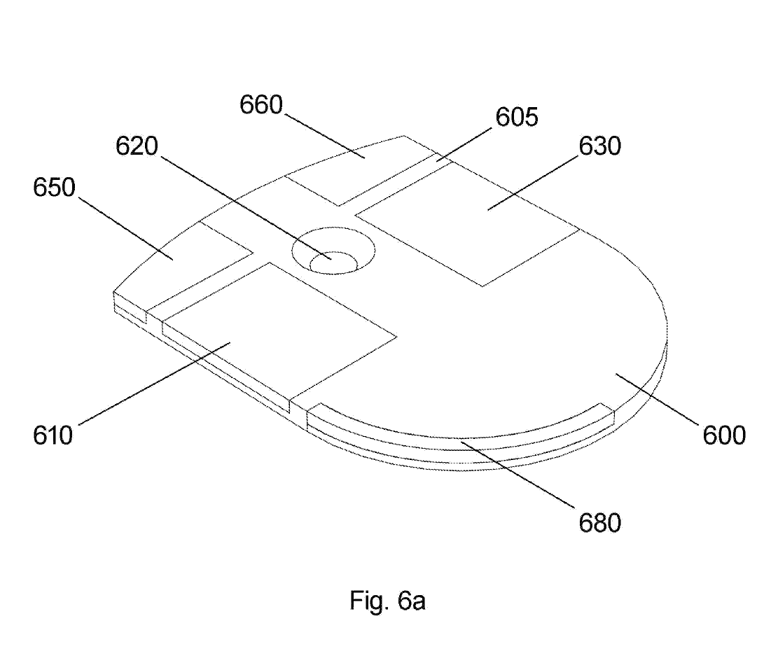

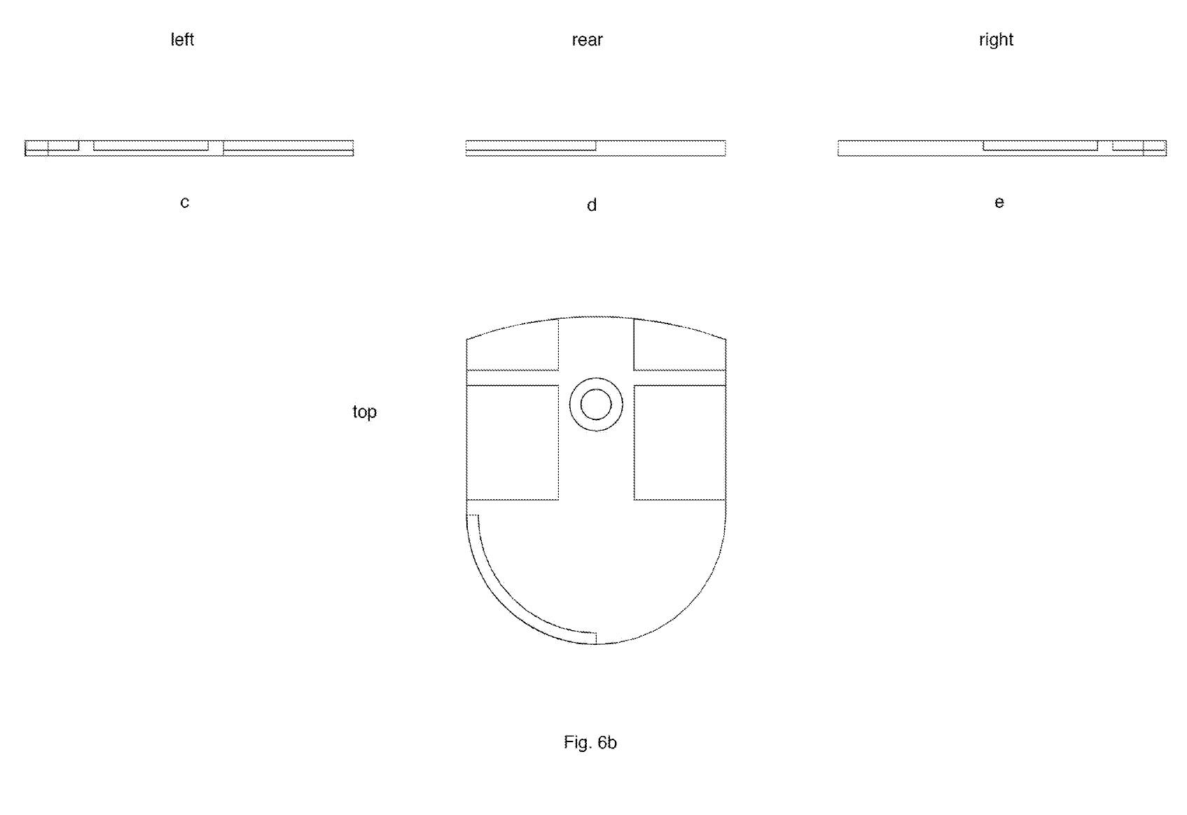

FIG. 6 shows a sixth embodiment of the invention;

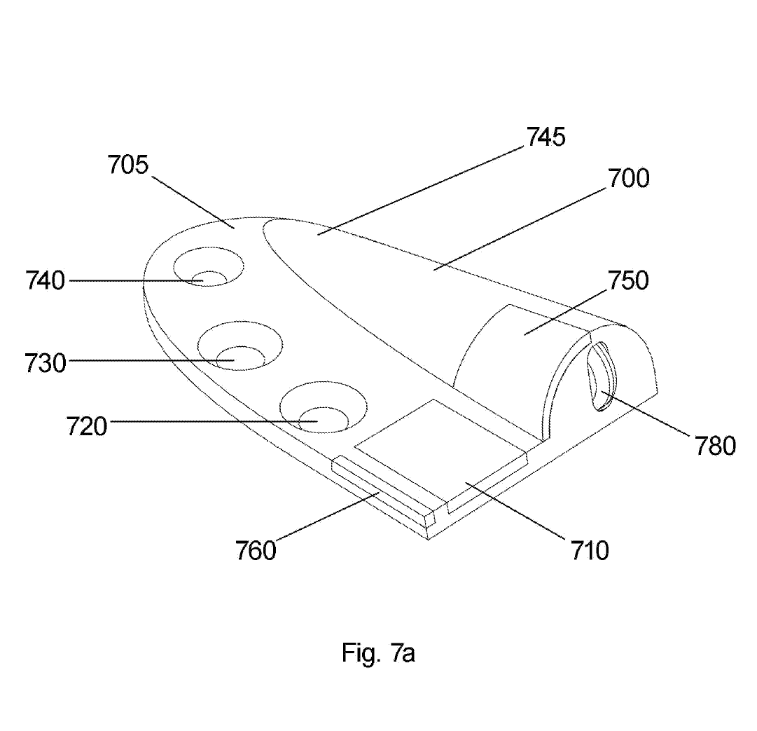

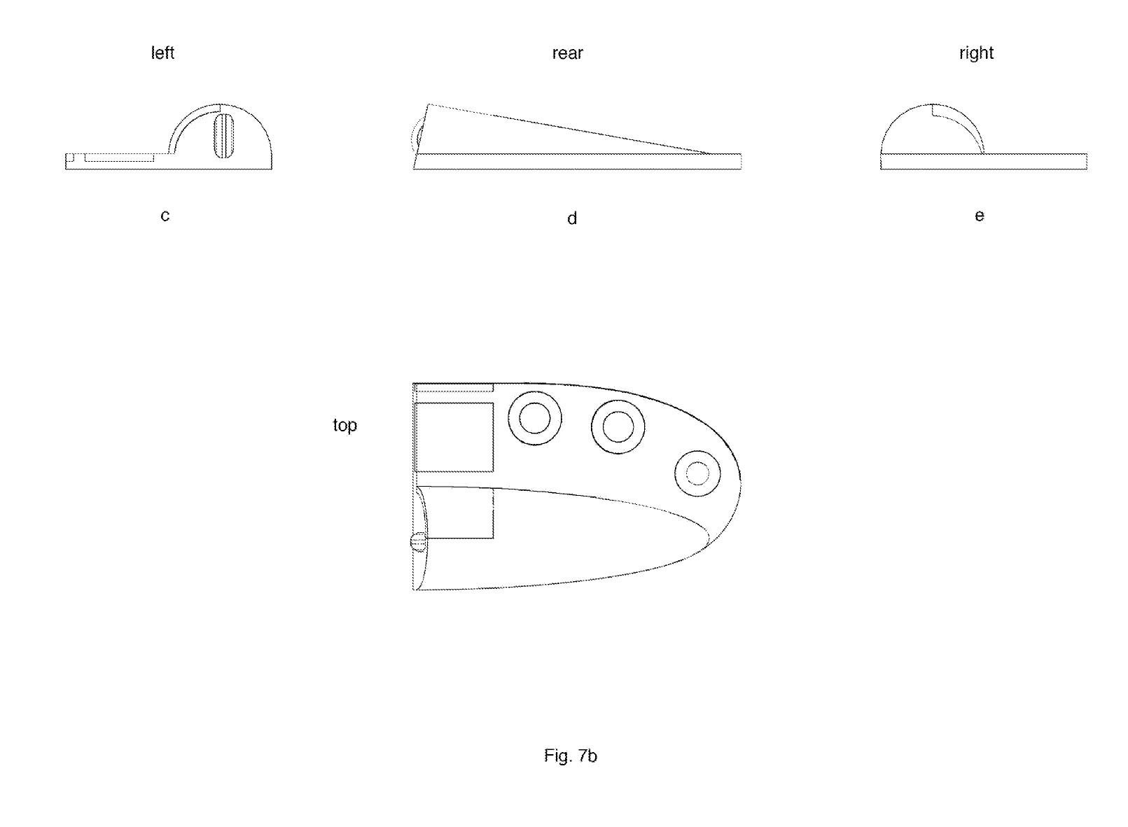

FIG. 7 shows a seventh embodiment of the invention;

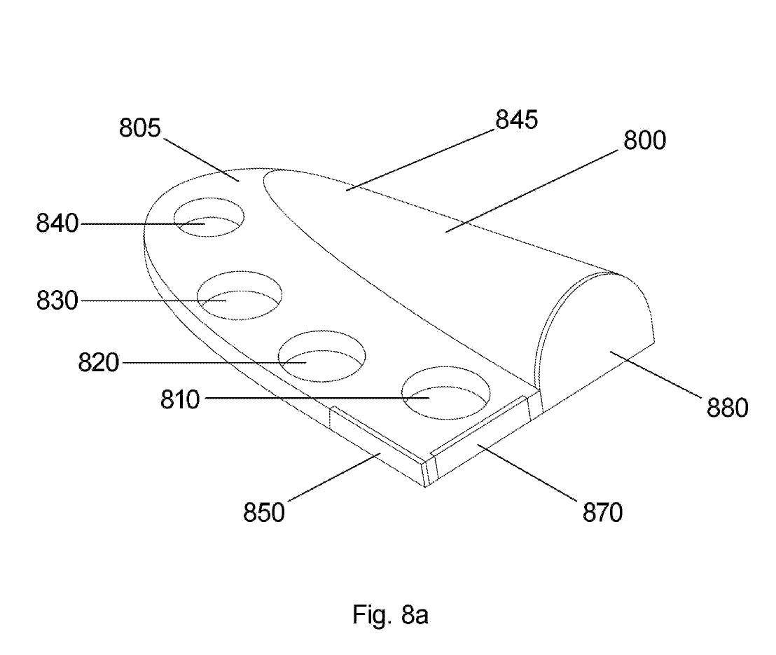

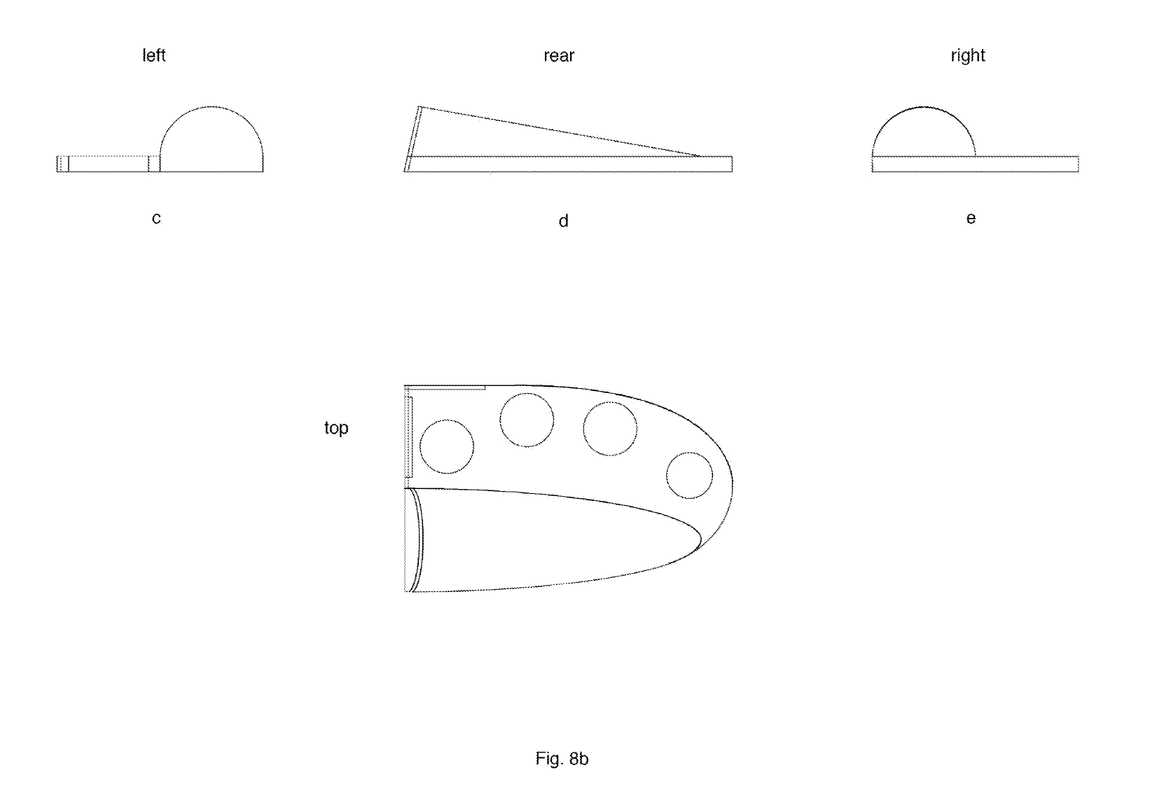

FIG. 8 shows an eighth embodiment of the invention;

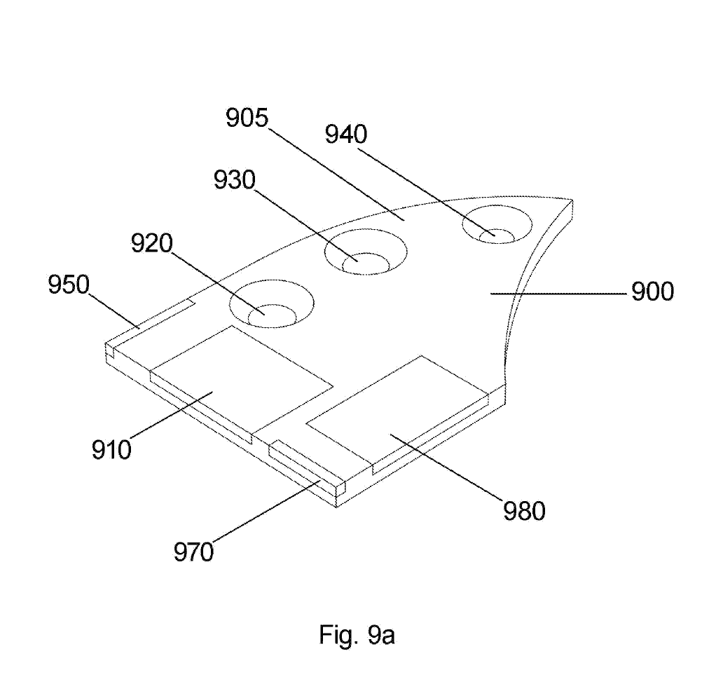

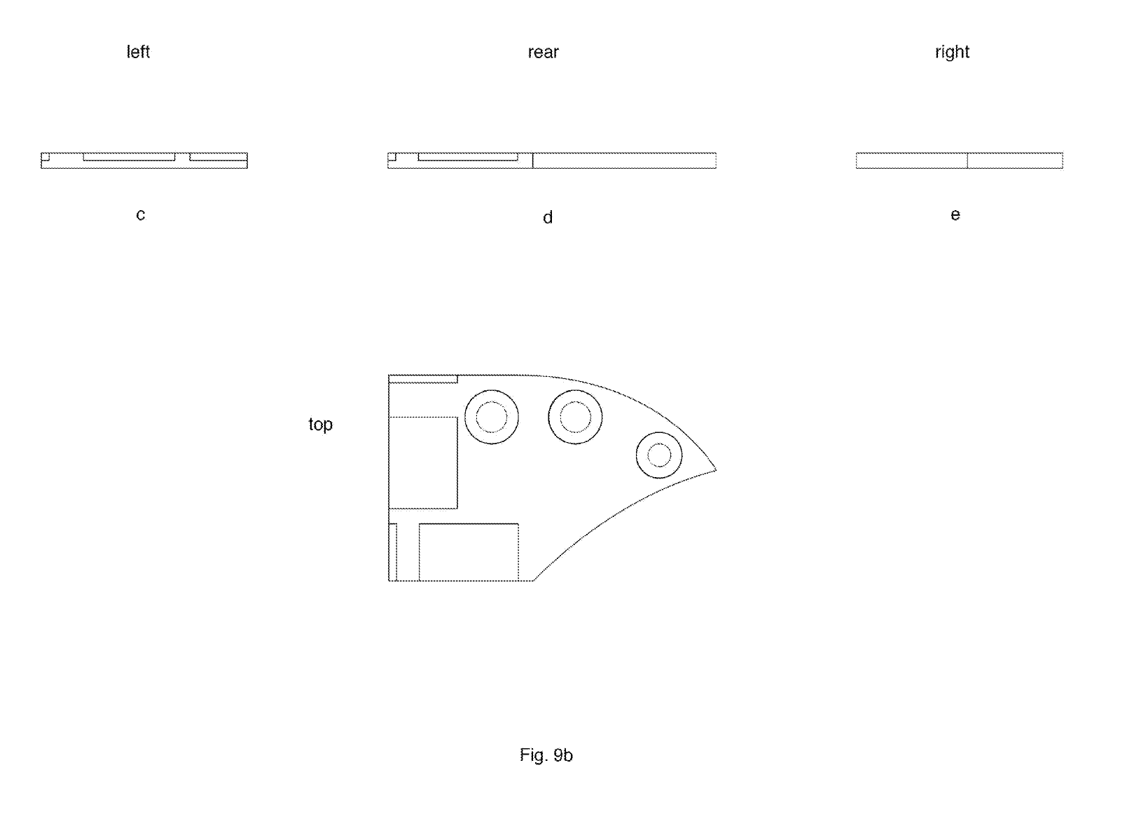

FIG. 9 shows a ninth embodiment of the invention;

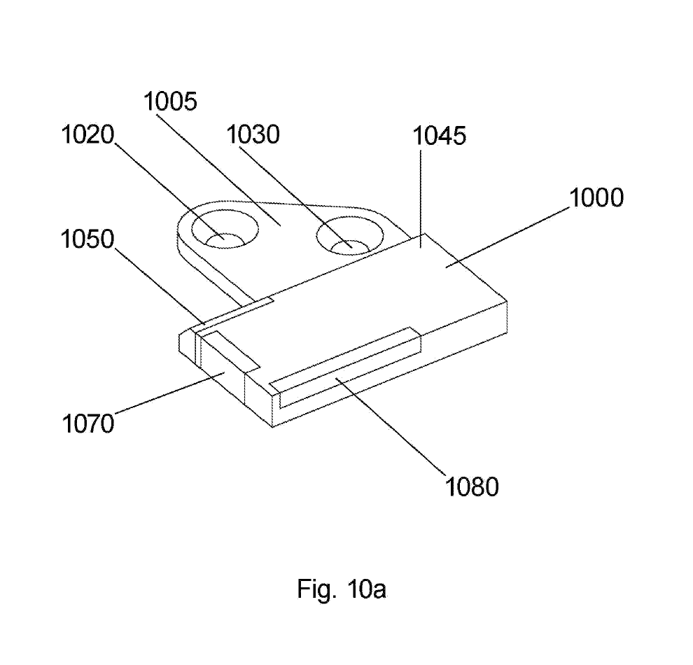

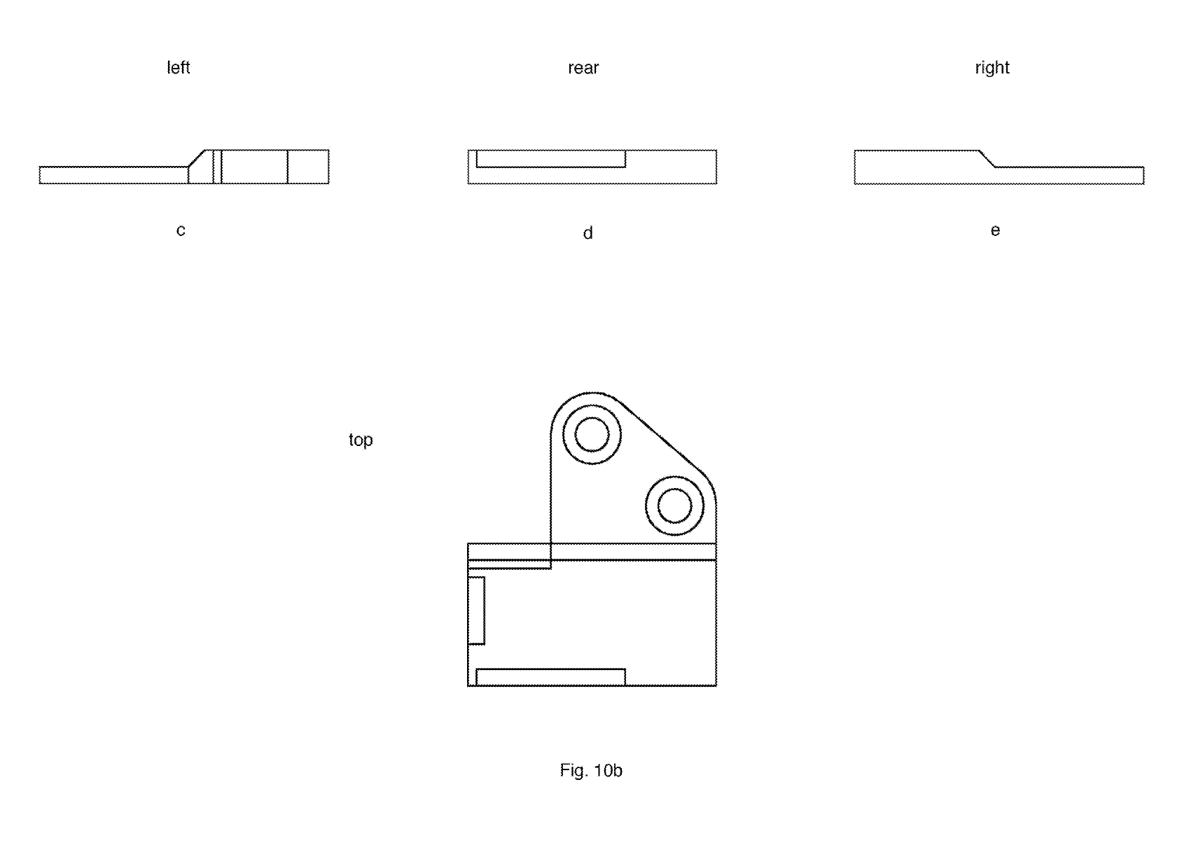

FIG. 10 shows a tenth embodiment of the invention;

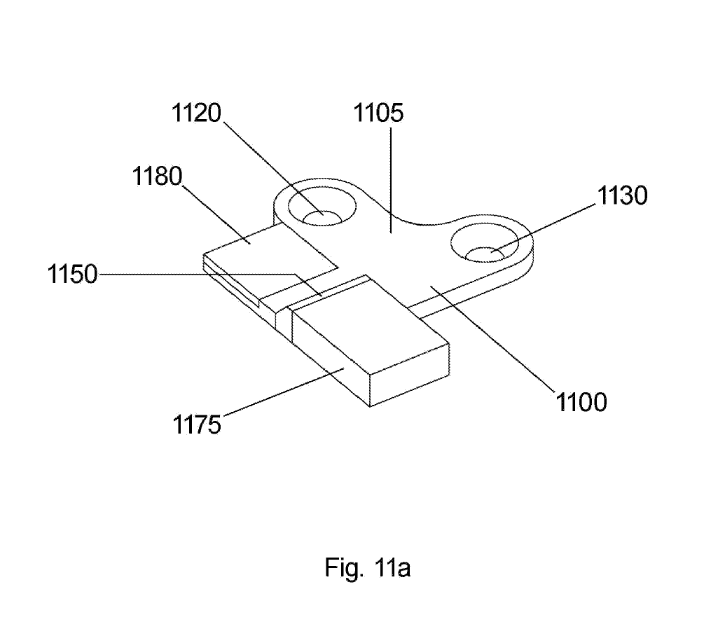

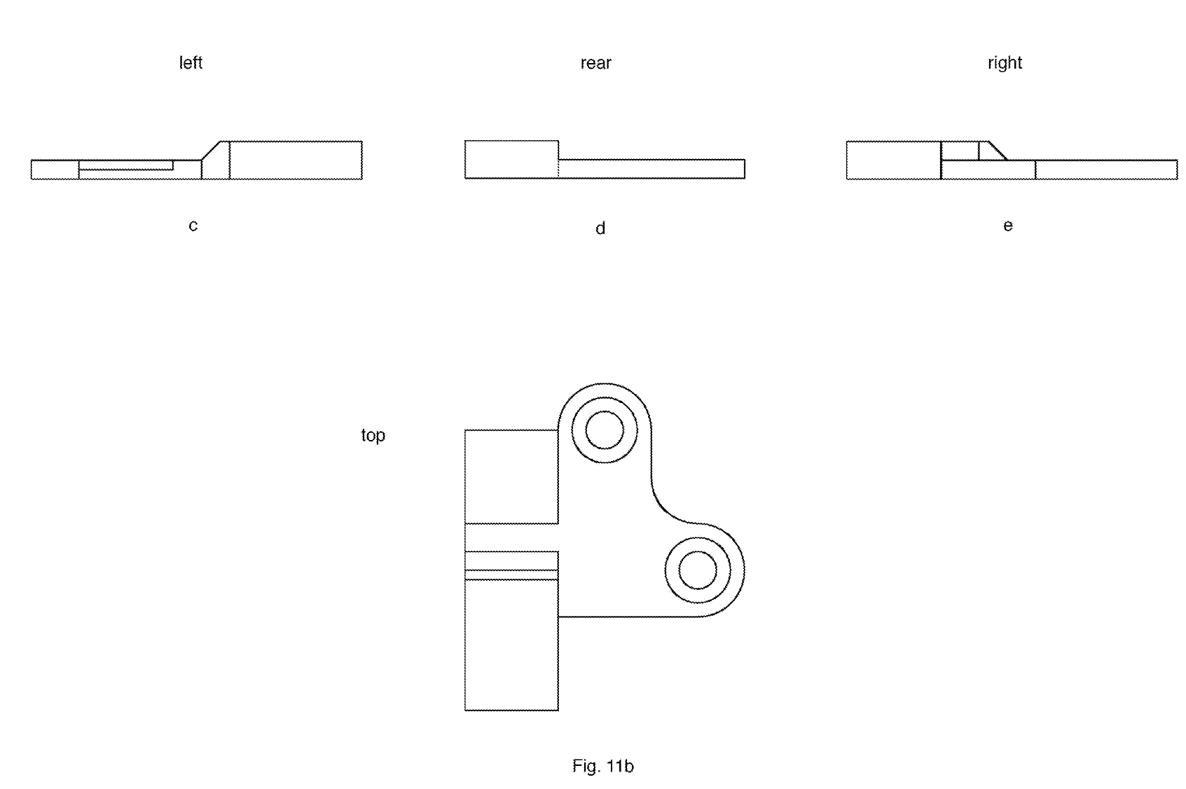

FIG. 11 shows an eleventh embodiment of the invention; and

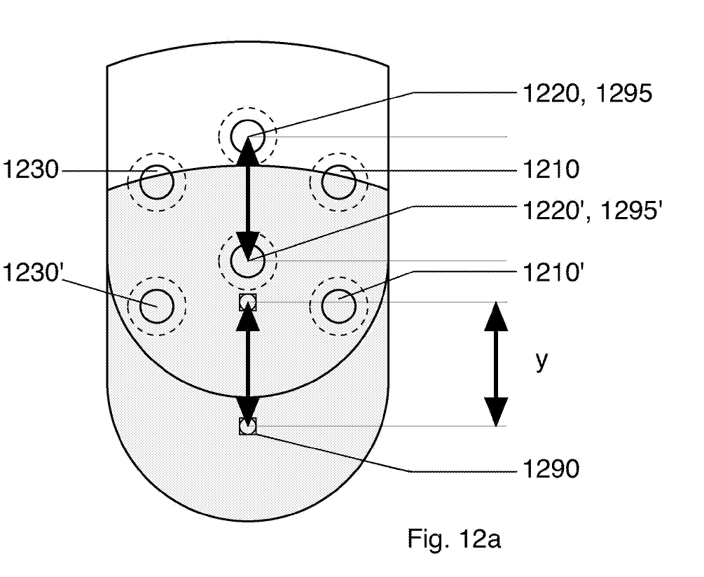

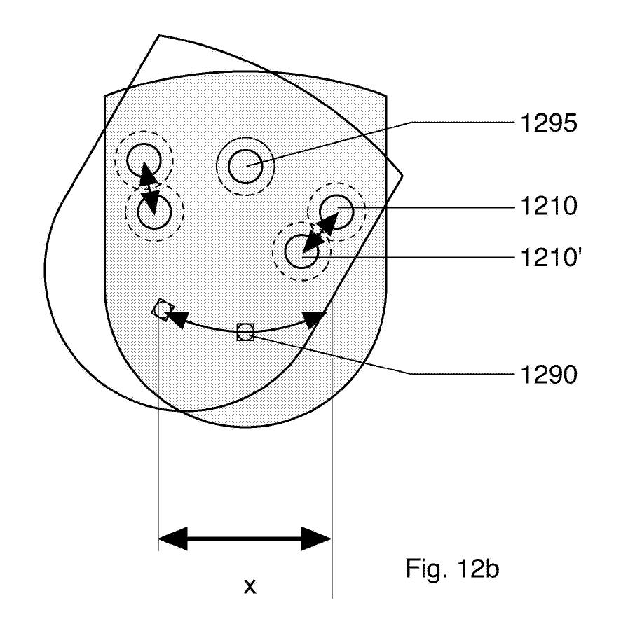

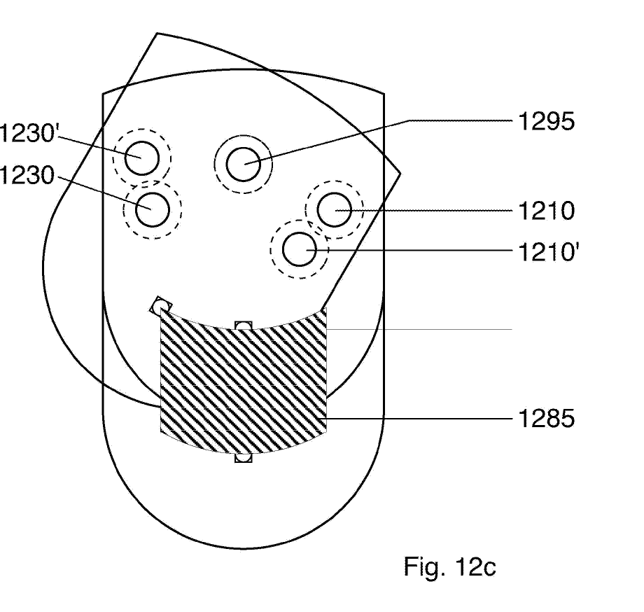

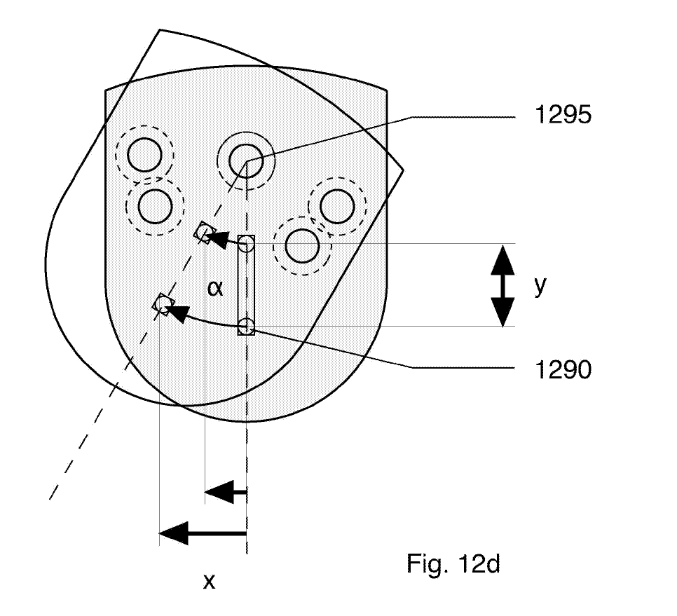

FIG. 12 shows a variant of the mouse in accordance with the invention, as viewed from below.

The FIGS. 1a, 2a, . . . 11a show the corresponding embodiment as viewed top down slanting, FIGS. 1b, 2b, . . . , 11B show the corresponding embodiment as viewed straight top down, all embodiments being illustrated oriented for right-handed use, FIGS. 1c, 2c, . . . , 11C corresponding as viewed from the left, FIGS. 1d, 2d, . . . , 11d as viewed from the rear and FIGS. 1e, 2e, . . . , 11e as viewed from the right.

Referring now to FIG. 1 there is illustrated how the mouse 100 in a first embodiment in accordance with the invention is configured totally flat top and bottom. The site for accommodating at least one finger tip is configured in the form of of three apertures 110, 120, 130. These apertures are disposed to accommodate the middle three fingers of a hand, they being arranged so that the fingers can be introduced without any muscular tension. Sited on the side is a first control (touchpad) 180 for thumb control without requiring any movement of the fingers guiding the mouse nor of the wrist. This pad 180 is sited in the “reach” of the thumb. Arranged furthermore before the aperture on the left is a second control 150 and a third control 160 for finger tip control by the index finger respectively the middle or ring finger. These controls too are in easy reach of the fingers for control. The control 150 is sited so that it permits control by means of the index finger like a pistol trigger, in other words by crooking the index finger.

Referring now to FIG. 2 there is illustrated how the mouse 200 in a second embodiment in accordance with the invention is configured for finger tip motion by the middle finger, ring finger and small finger. The first control 250 and the second control 270 are sited juxtaposed on the side so that the first 250 can be fingered by the index finger and the second 270 with the thumb. Also shown is a third control 280 which may be provided instead of control 250 or 270 or also in addition, thereto.

The topology of the apertures and controls of the mouse 300 as shown in a third embodiment corresponds to that for the finger arrangement of the second embodiment, except that now it is configured essentially in a cheque card format for particularly elegant saving in transport. Here too a control 350 is arranged so that it can be triggered by the crooked index finger. In addition, a touchpad 380 is provided for thumb and index finger control.

The mouse 400 as shown in its fourth embodiment is again configured in a cheque card format. The site for accommodating the fingers is formed by three concavities 420, 430, 440, whilst 410 is a tactile surface for the index finger. 450 represents a button for the index finger, 470 a thumb button. Also provided is a touch slider for the thumb (480).

The mouse 500 as shown in its fifth embodiment, again in a cheque card format, comprises four apertures 510, 520, 530, 540 for accommodating the fingers. Three controls 550, 570, 580 are provided, each of which can be configured individually, i.e. not every control needs to be activated. The multi-finger mobility afforded by the this embodiment makes for enhanced accuracy so that this mouse is particularly suitable for applications demanding high precision.

In the mouse 600 as shown in its sixth embodiment the finger tip site for moving the mouse is formed by a central aperture 620 flanked on both sides by planar sites 610, 630.

The central aperture 620 is configured to accommodate the middle finger whilst the flanking sites 610 and 630 are intended for the index finger or ring finger. The two flanking sites 610 and 630 are configured as tactile surfaces, e.g. made of plastics. Located on the side is a control 680 for the thumb, a second control 650 for the index finger sited before the flanking site 610 on the left and a third control 660 for the ring finger sited before the flanking site 630 on the right. This mouse is designed for particularly easy movement.

The mouse as shown in the seventh embodiment of the invention features three concavities 720, 730, 740 for the middle finger, the ring finger and the small finger as well as a tactile surface for the index finger. These apertures (as well as the tactile surface) are arranged in a flat site 705 flanked in an elevated site 745 by two controls 750, 780 for index finger and thumb control. Actuation of the first control 750 is again by the crooked index finger like a trigger. Additionally arranged is a button 760 above the index. The elevated site 745 is formed so that it does not come into contact with the palm of the hand or wrist. This mouse too is designed for particularly easy movement. The space made available below the elevated site 745 can be used to accommodate mechanical and/or electronic components of the motion sensing device.

Referring now to FIG. 8 there is illustrated how the finger sites are topologically the same as for the embodiment shown in FIG. 7, except that the sites for accommodating the fingers are now engineered as apertures instead of concavities. Apart from this, an additional aperture 810 is provided for the index finger.

Referring now to FIG. 9 there is illustrated an embodiment the same as that as shown in FIG. 2 as regards the finger topology, except that the sites for accommodating the fingers are now engineered as concavities instead of apertures. In addition, a tactile surface 910 for the index finger is integrated.

The embodiments as shown in FIGS. 10 and 11 are configured particularly compact. Referring now to FIG. 10 there is illustrated how motion is provided for just two fingers, namely with the middle finger (aperture 1020) and the ring finger (aperture 1030). Provided for thumb control is a touch slider 1080 and a button 1070 whilst for index finger control a button 1050 is included as a trigger control.

Referring now to FIG. 11 there is illustrated a configuration comprising two apertures 1120 and 1130 for the middle finger and ring finger respectively as well as a pad 1175 for the thumb. Provided for index finger control is a button 1150 and a touch slider 1180, the button 1150 being a trigger control. Also provided is an elevated site 1175 for thumb control as is particularly practical when rotating the mouse counter-clockwise.

FIGS. 12a-d illustrate a further aspect of the present invention, showing the mouse 900 from below, the same as shown in FIG. 9. The special feature of this variant is that the device 1290 for translating the movement of the mouse into an (electrical) signal is sited on the underside so that rotation of the mouse about this fulcrum results in activation thereof, i.e. the device 910 is arranged outside of the fulcrum of the mouse. The fulcrum of the mouse is oriented perpendicular to the plane in which the mouse is moved through the fulcrum 1295, 1295′, coinciding with the aperture 1220, 1220′ for the middle of the three fingers moving the mouse. The apertures 1210, 1230, and 1210′, 1230′, respectively, correspond to the respective apertures of the mouse of FIG. 9.

Moving the mouse horizontally back and forth, in other words in the y direction, then corresponds to a vertical movement of the cursor on the display, cf. FIG. 12a . Moving back and forth is done by crooking and extending the (in this case “guiding”) middle finger. Rotating the mouse in the horizontal is done by counter acting crooking and extending the (in this case “controlling”) ring finger or index finger resulting in the sensor 1290 being moved to the left and right respectively in the horizontal, cf FIG. 12b . This corresponds to a horizontal movement of the cursor on the display. It is of advantage in this arrangement that the sensor 1290 covers a considerably large site without having to change the position of the hand or wrist, in other words the wrist of the hand concerned can remain parked when moving the mouse in this site. As compared to use of a conventional mouse this puts much less strain on the hand in controlling the mouse.

Referring now to FIG. 12c there is illustrated the site 1285 within which movement of the mouse is possible without having to change the position of the wrist, in other words purely by finger movements.

Referring now to FIG. 12d there is illustrated how the sensitivity of the sensor 1290 is function of the distance away from the fulcrum 1295, i.e. the more the distance away from the fulcrum 1295, the greater the sensing of the movement when the mouse is rotated. Rotating the mouse about a certain angle α thus corresponds to a deflection x becoming all the more horizontal with the distance away from the fulcrum.

When the fulcrum 1295 of the mouse coincides with the center of gravity of the mouse the twist required to rotate the mouse is an absolute minimum, the center of gravity then corresponding to the center of the actual distribution of the mass of the mouse. For instance, the center of gravity may also be provided as the fulcrum 1295 as would result with a homogenous distribution of the mass of the mouse over the surface of the mouse.

It is to be noted that the aspect of the invention as described in conjunction with FIG. 12 can be combined with any of the variants of the invention as described above, although also by itself it is considered as being an invention.

In the embodiment as shown in FIG. 10 the fulcrum is formed by the aperture 1020, the rotary motion being produced by the ring finger in the aperture 1030.

In the embodiment as shown in FIG. 11, by contrast, the fulcrum is formed by the aperture 1120; the rotary motion in this case being produced clockwise by means of the ring finger in the aperture 1130 and counter clockwise by means of the thumb on the pad 1175.

### LIST OF REFERENCE NUMERALS

The numerals identifying the various elements in accordance with the embodiments as described are to be understood as follows: the first digit corresponds to the number x of the FIG, followed by a two-digit number for a more specific identification of the element in the FIG, whereby like numerals identify like, or corresponding, elements. Thus, x in FIG. 1 receives the numeral 1, accordingly the basic item of FIG. 1, for example, is identified as 100, that of FIG. 11 as 1100, and so on.
X00: basic item
X05: flat site
X10: concavity/tactile surface for index finger
X20: concavity for middle finger
X30: concavity/tactile surface for ring finger
X40: concavity for small finger
X50: button 1 (index finger)
X60: button 2 (other finger)
X70: thumb button
X75: thumb rest
X80: touch slider/pad or scroll wheel (thumb or index finger)
X85: site requiring no change in hand position
X90: sensor (underside)
X95: fulcrum

1. A manual input device configured for translating a planar movement of the manual input device into an electrical signal, comprising:
a site for accommodating at least one top down finger tip, the site being configured such that the manual input device can be moved in any planar direction by means of at least one finger tip of a hand, the wrist thereby resting planar.

2. The manual input device as set forth in claim 1 wherein the site comprises at least one concavity configured to accommodate at least one finger tip.

3. The manual input device as set forth in claim 1 wherein the site comprises at least one surface configured to accommodate at least one finger tip.

4. The manual input device as set forth in claim 1 wherein the surface is provided with a tactile surface.

5. The manual input device as set forth in claim 1 wherein the the site comprises at least one aperture configured to accommodate at least one finger tip.

6. The manual input device as set forth in claim 1 wherein the site is configured planar.

7. The manual input device as set forth in claim 1 wherein the site is configured flat.

8. The manual input device as set forth in claim 1 wherein the manual input device is configured substantially planar over its full surface.

9. The manual input device as set forth in claim 1 comprising at least one control, particularly a button, scroll wheel, touch pad, arranged such that it can be actuated by means of at least one finger of a hand, it being arranged offset from the site which is to serve for finger tip guidance thereof

11. The manual input device as set forth in claim 1 further comprising at least one control, particularly a button, scroll wheel, touch pad, arranged such that it can be actuated by means of up and down movement of a thumb.

12. The manual input device as set forth in claim 1, wherein its planar extent is large as compared to the height of the manual input device.

13. The manual input device as set forth in claim 1, the top and underside of which are configured substantially flat.

14. The manual input device as set forth in claim 1, the underside of which rests fully planar.

15. The manual input device as set forth in claim 1, the dimensions of which are substantially those of a cheque card.

16. The manual input device as set forth in claim 1, at least one of the controls of which is used like a pistol trigger.

17. The manual input device as set forth in claim 1 further comprising: an elevated site configured to accommodate at least one control.

18. The manual input device as set forth in claim 1, the elevated site remaining untouched by the palm of the hand when controlled.

19. A manual input device configured for translating a planar movement of the manual input device into an electrical signal, particularly in accordance with claim 1, comprising:
a device for translating the movement into a signal, the device being arranged at the underside, preferably outside of a vertical through the fulcrum of the manual input device relative to the horizontal.
